(19) United States
(12) Patent Application Publication
(10) Pub. No.: US 2013/0313316 A1
(43) Pub. Date: Nov. 28, 2013

(54) SYSTEM FOR AND METHOD OF EXPEDITING CHECKOUT AT POINT-OF-SALE STATIONS

(71) Applicant: David A. Jones, Decatur, GA (US)

(72) Inventor: David A. Jones, Decatur, GA (US)

(73) Assignee: Symbol Technologies, Inc., Schaumburg, IL (US)

(21) Appl. No.: 13/477,159

(22) Filed: May 22, 2012

(51) Int. Cl. G06Q 90/00

(52) U.S. Cl. 235/383

(57) ABSTRACT

An apparatus and method for expediting checkout at a point-of-sale station, employ a mobile electronic device, e.g., a cellular phone, having a customer interface for enabling a customer to enter personal textual information that identify the customer and/or financial textual information that identify how the customer intends to pay for items to be purchased at the station. A device controller generates a two-dimensional symbol from the entered textual information. The two-dimensional symbol is displayed on a display screen of the device. An electro-optical scanner electro-optically reads the displayed two-dimensional symbol by image capture to retrieve the entered textual information.

### FIELD OF THE DISCLOSURE

The present disclosure relates generally to a system for, and a method of, expediting checkout at point-of-sale stations.

### BACKGROUND

Retail establishments are trying to become more efficient by applying different and innovative operating methods that help to increase their business's financial condition. One of their constantly pursued goals is the reduction of a customer's waiting time in a checkout line. Being able to speed up the flow of customers through a checkout or point-of-sale (POS) station, or to reduce the cost of a checkout transaction, is critical to the success of a retail business. Manual price keying of each item being purchased has been substantially replaced at each POS station by laser-based and/or solid-state imager-based electro-optical readers, also known as scanners, that automatically scan and read machine-readable symbols, e.g., a one-dimensional symbol, particularly a Universal Product Code (UPC) bar code symbol, associated with each item, and/or a two-dimensional symbol, particularly a PDF417 symbol or a QR code symbol, associated with one or more items. Examples of such scanners include handheld, portable scanners; stand-mounted, stationary scanners; vertical slot scanners; flat-bed or horizontal slot scanners; and bi-optical, dual window scanners.

In a typical retail checkout transaction, a customer sequentially presents all the items he or she wants to purchase to a cashier at a checkout register at each POS station. The cashier scans the symbol on each item in the order in which it is presented to the cashier. In addition, there may be an age-identification check if the customer is purchasing a restricted item, such as, but not limited to, alcohol or tobacco. Once all the symbols have been scanned, and all the items have been identified, and prices for all the identified items have been retrieved from a price database, a total cost of the transaction is calculated, and the customer pays for the items. If a credit/debit card having a magnetic stripe is used for payment, then the card is swiped through magnetic heads of a card reader. During this checkout transaction, the cashier will sometimes ask for personal information, e.g., the customer's name, postal address, email address, etc. Many retailers want this personal information for direct marketing purposes, which is another constantly pursued goal. Retailers want to send promotional and advertising information, including discount coupons, directly to customers to get them to return to their establishments in the future for additional shopping.

Even though scanning all the symbols on all the items at a checkout register takes less time than manually keying each item, the process of asking for personal information, the process of paying by credit card, and the process of checking a customer's age can, either individually or collectively, take a long time and can create long lines of customers waiting to pay for their purchases. Some customers are leery of providing such personal information, especially confidential information, for security reasons, and, in some cases, may be embarrassed to provide their age, within earshot of waiting customers and others who can overhear the verbal exchange between the cashier and the customer. Such distrustful customers might whisper the personal information, thereby prolonging the verbal exchange, or may simply refuse to divulge such personal information, again delaying the checkout transaction. Some customers who have many credit cards may not expeditiously find the right one, or may have to manually key in security codes or pin numbers, all of which slow down the checkout transaction. These processes can cause bottlenecks at the POS stations, reduce throughput, make customers unhappy, compromise customer security, and deleteriously affect the financial condition of the retail establishment.

To at least partially alleviate such drawbacks, self-service checkout or “self-checkout” systems are employed, wherein each customer, rather than the cashier, scans the symbols on the items being purchased. However, such self-checkout systems deny the retailer the opportunity to have a cashier gather the personal information, thereby thwarting the retailer's attempt to build and implement an effective direct marketing campaign, as well as performing effective identification checks.

Accordingly, it would be desirable to expedite checkout throughput by decreasing the amount of time needed to process item transactions at a POS station, by gathering personal information in a secure, expeditious manner to support the retailer's efforts to build and implement an effective direct marketing campaign, and by paying for the item transactions with financial information presented in a secure, expeditious manner without resort to using credit/debit cards.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of a representative mobile device during presentation to a representative scanner installed at a point-of-sale station in a retail store in accordance with this invention.

FIG. 2 is a front view of the representative mobile device displaying an electronic two-dimensional code to be imaged by the scanner of FIG. 1.

FIG. 3 is a part-schematic, part-diagrammatic view depicting various components of the representative mobile device of FIG. 2.

FIG. 4 is a screenshot of a text menu displayed on the representative mobile device of FIG. 2 during setup.

FIG. 5 is a screenshot of a generate menu displayed on the representative mobile device of FIG. 2 during setup.

FIG. 6 is a screenshot of a display menu displayed on the representative mobile device of FIG. 2 during setup.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A system and method, in accordance with one feature of this invention, are operative for expediting checkout at a point-of-sale station. A mobile electronic device is advantageously configured as a cellular telephone, a smartphone, a personal digital assistant, a tablet, a computer, an e-reader, a media player, or a like portable electronic device. The device has a customer interface, e.g., a keyboard having real or virtual keys, for enabling a customer to enter personal textual information that identify the customer and/or financial textual information that identify how the customer intends to pay for items to be purchased at the station. The personal textual information includes one or more of such data as the customer's name, address, telephone number, email address, age, and website. The financial textual information includes one or more of such data as the customer's payment card type, card number, expiration date and security code.

The device also has a device controller, e.g., a programmed microprocessor, operative for generating a two-dimensional symbol from the entered textual information, and a display screen on which the two-dimensional symbol is displayed by the device controller. An electro-optical scanner at the point-of-sale station, is operative for electro-optically reading the displayed two-dimensional symbol by image capture to retrieve the entered textual information. The scanner is advantageously configured as one of a handheld, portable scanner; a stand-mounted, stationary scanner; a vertical slot scanner; a flat-bed, horizontal slot scanner; and a bi-optical, dual window scanner.

In a text mode of operation, the device controller displays, on the display screen, a plurality of textual fields in which the personal textual information and/or the financial textual information are entered by the customer. In a generate mode of operation, the device controller enables the customer to select different sets of the textual fields, and generates the two-dimensional symbol from the entered textual information in each set of the selected textual fields. In a display mode of operation, the device controller identifies the different sets to enable the customer to select one of the sets to be used for generating the two-dimensional symbol. Advantageously, one of the identified sets contains only the personal textual information, another of the identified sets contains only the financial textual information, and still another of the identified sets contains both the personal textual information and the financial textual information.

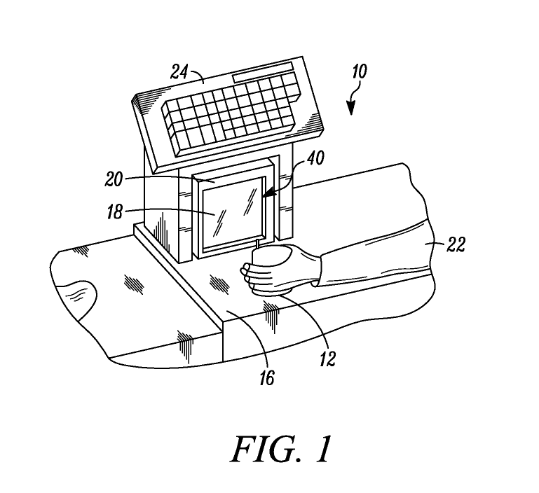

Reference numeral 10 in FIG. 1 generally identifies a representative checkout or point-of-sale (POS) station in a retail store. Items to be purchased are distributed throughout the store, each item bearing, or being associated with, an identifying machine-readable, bar code symbol, e.g., a one-dimensional symbol, particularly a Universal Product Code (UPC) bar code symbol. A shopper or a customer travels through the store during a shopping trip and selects individual items to be purchased prior to presenting the items for checkout at the station 10.

An electro-optical reader or scanner 40 (configured as a vertical slot scanner in FIG. 1) is provided at the station 10 and, as illustrated, has a box-shaped housing 20 mounted on a countertop 16 of the station 10. The housing 20 has a generally vertical or upright, generally planar, light-transmissive window 18. The symbols on the items being purchased are presented to, and/or slid past and across, the window 18. The scanner 40 has an imaging module for capturing an image of each symbol at the window 18, and a main controller for processing, decoding and reading the symbol. Although illustrated as a vertical slot scanner 40, the scanner 40 could also be configured as a handheld, portable scanner; a stand-mounted, stationary scanner; a flat-bed or horizontal slot scanner; or a bi-optical, dual window scanner.

A user 22, e.g., the customer or a clerk, may be located at one side of the countertop 16, and the housing 20 may typically located at the opposite side. A cash/credit register 24 is located within easy reach of the user 22 to facilitate the processing and checkout of the item transactions. It will further be understood that the station 10 need not be configured as being located at the illustrated checkout counter at a retail site with the cash register 24, but that other non-retail venues without the register 24 are contemplated.

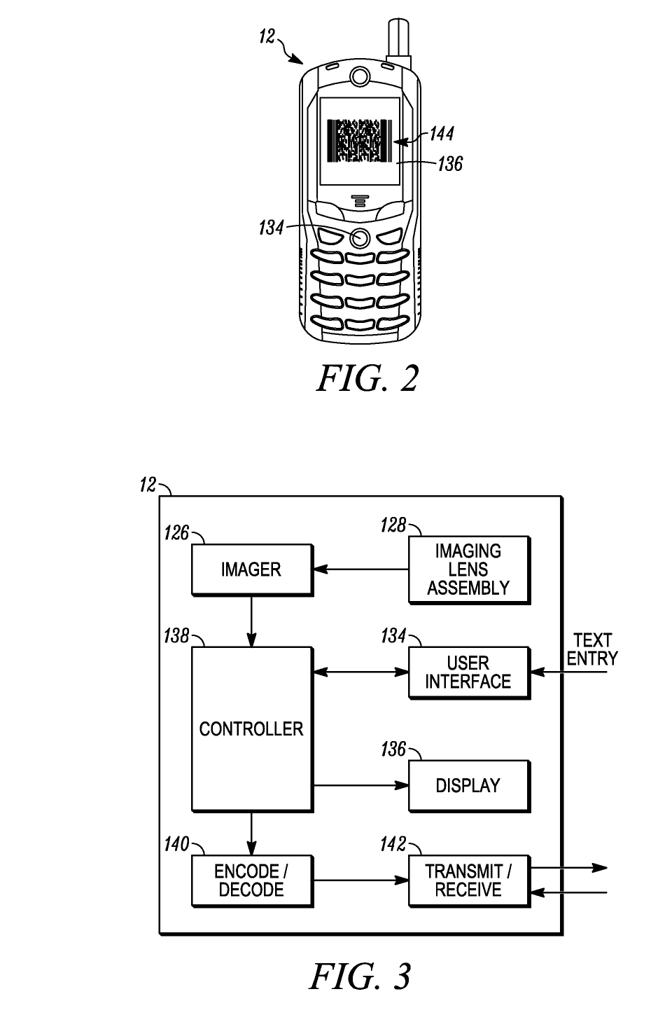

In accordance with one aspect of this invention, a two-dimensional bar code symbol 144 (see FIG. 2) is displayed on a mobile electronic device 12, as described in detail below. As shown in FIG. 1, this two-dimensional symbol 144 is also presented to, and/or slid past and across, the window 18 in order to expedite the checkout transaction. The device 12 need not be configured as the illustrated wireless telephone of FIG. 2 (“cellular phone” or “smartphone”), but could be any portable device, such as a personal digital assistant (“PDA”), an e-reader, a tablet, a slate, a computer, a media player, or any like portable device generally carried on one's person and thus readily available and accessible.

As shown in FIG. 3, the device 12 includes a device sensor or imager 126, e.g., a solid-state device, for example, a charge coupled device (CCD) or a complementary metal oxide semiconductor (CMOS) device, having an array of addressable image sensors or pixels, preferably of submegapixel or supermegapixel size, an imaging lens assembly 128 mounted in front of the imager 126, and a device controller 138, such as a programmed microprocessor, for controlling these components. An imager (corresponding to the device imager 126), an imaging lens assembly (corresponding to the imaging lens assembly 128), and a controller (corresponding to the device controller 138) are mounted within the scanner 40, for together capturing return light from, and imaging, the two-dimensional symbol 144 on the device 12, as described below.

The device 12 also includes an encode/decode module 140 and a transceiver module 142 when the device is a phone, as well as a customer/user interface 134, such as the real keys on the device in FIG. 2, and a display screen 136. If the display screen is touch sensitive, then the user interface 134 can comprise a set of virtual keys. The device controller 138 is operative for controlling all the electrical components in the device 12. The real/virtual keys are activated to enable the customer to manually enter personal textual information that identify the customer, and/or financial textual information that identify how the customer intends to pay for items to be purchased at the station 10.

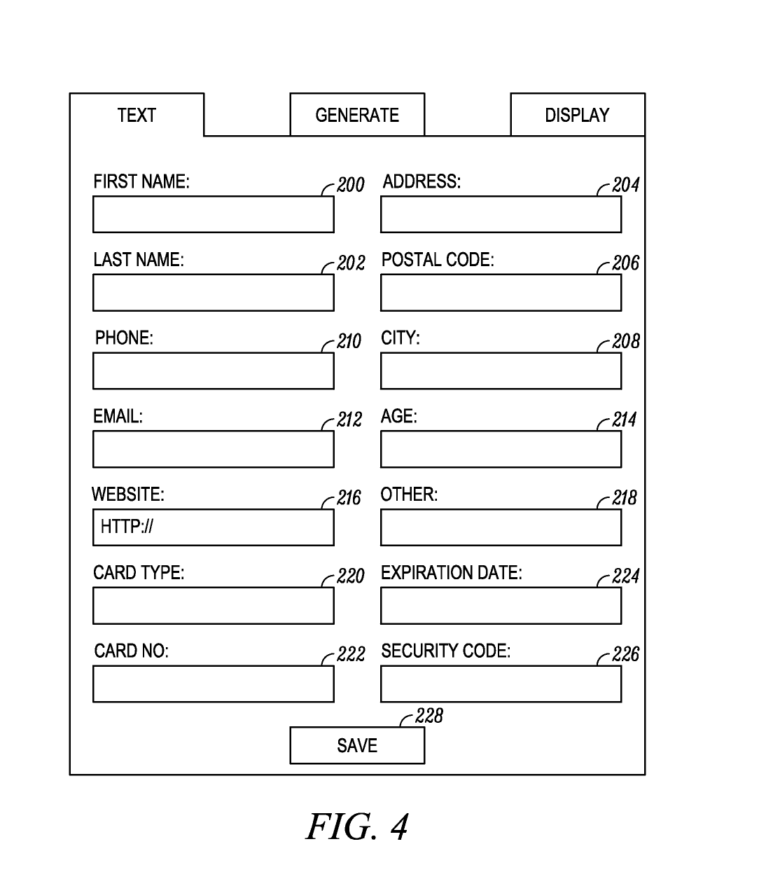

As depicted in the screenshot of FIG. 4, the personal textual information is manually entered in various fields displayed by the controller 138 on the screen 136 during setup in a text mode of operation, and includes one or more of the customer's name (fields 200, 202), address (fields 204, 206, 208), telephone number (field 210), email address (field 212), age (field 214), website (field 216), and other information (field 218). The financial textual information is also manually entered in various fields in the text mode of operation, and includes one or more of the customer's payment card type (field 220), card number (field 222), expiration date (field 224), and security code (field 226). A virtual save button 228 saves all the entered information in a memory accessible by the controller 138. The device controller 138 is further operative for generating the two-dimensional symbol 144 from the entered textual information, and for displaying the two-dimensional symbol 144 on the screen 136.

The process of encoding a two-dimensional bar code symbol is described in detail in U.S. Pat. No. 5,243,655, the entire contents of which are incorporated herein by reference thereto. That patent describes a PDF417 bar code specification and describes how data is encoded into this type of two-dimensional bar code symbol. The PDF417 symbol 144 is capable of encoding more than 1100 bytes, 1800 text characters or 2710 digits. Large data files can be encoded into a series of linked PDF417 symbols using a standard methodology referred to as Macro PDF417. Further details describing encoding of information into a two-dimensional bar code symbol are available in ISO standard 15438, the entire contents of which are incorporated herein by reference thereto.

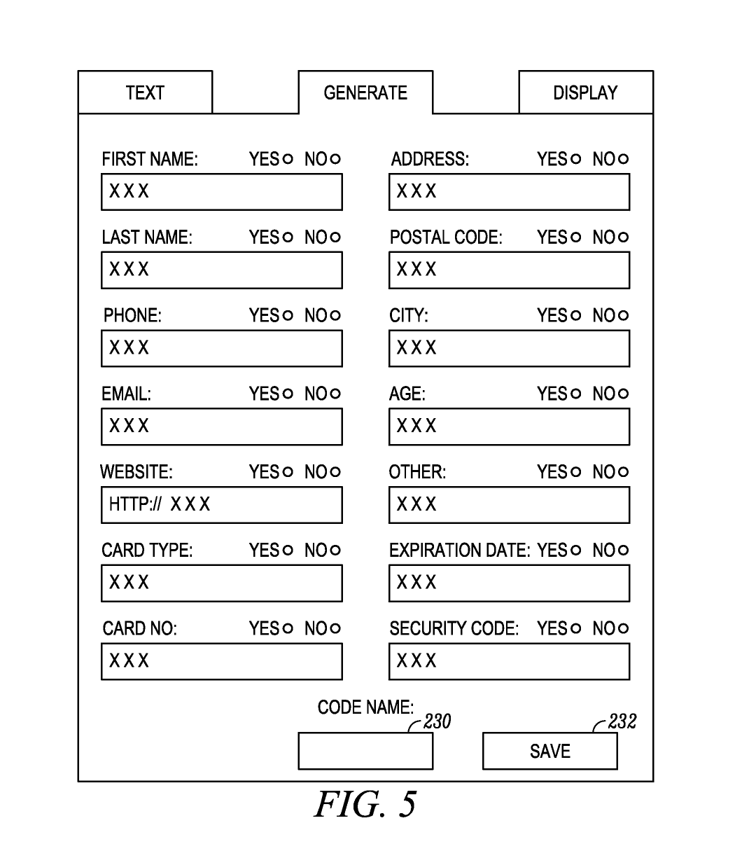

Once the entered textual information has been saved, the customer can select a generate menu, which is depicted in the screenshot of FIG. 5. In the generate mode of operation, the device controller 138 enables the customer to select different sets of the textual fields, and to assign different names for each set. As illustrated, this is advantageously accomplished by selection between the illustrated YES or NO radio buttons adjacent each field. Other selection techniques could, of course, be employed. The customer can name each set by manual entry of text into field 230, and thereupon saving the named set by activating the virtual save button 232. In response, the device controller 138 generates a two-dimensional symbol from the entered textual information for each named set of the selected textual fields.

For example, if the customer selects one or more of the fields 200-218, then this first set contains only the personal textual information, and can be named and saved as “personal code”, or like nomenclature. If the customer selects one or more of the fields 220-226, then this second set contains only the financial textual information, and can be named and saved as “financial code”, or like nomenclature. If the customer selects all of the fields 200-226, then this third set contains both the personal textual information and the financial textual information, and can be named and saved as “master code”, or like nomenclature.

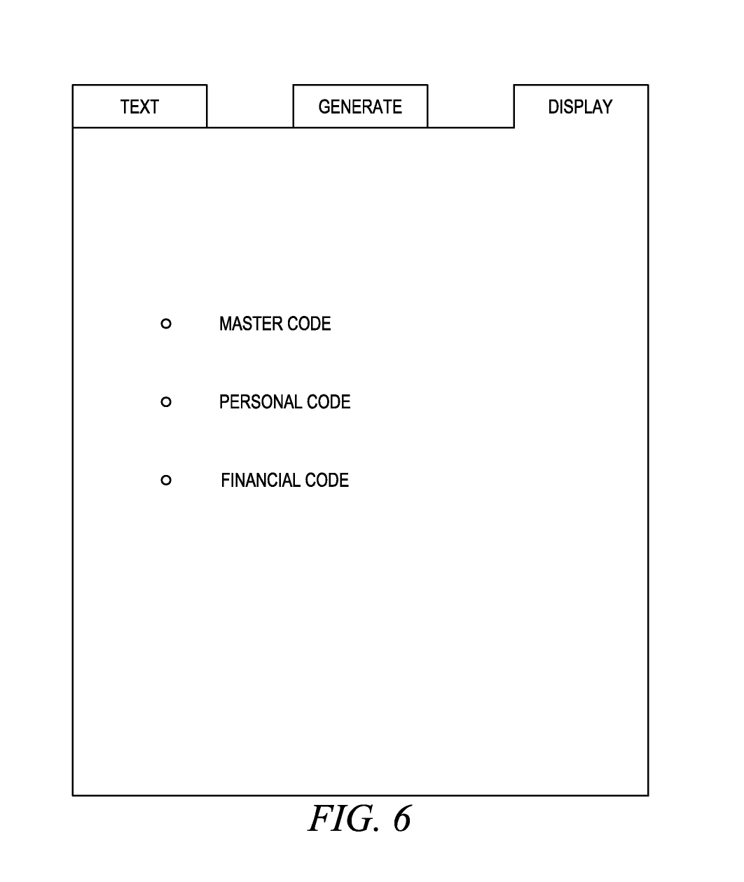

Once the named sets have been saved, the customer can select a display menu, which is depicted in the screenshot of FIG. 6. In the display mode of operation, the device controller 138 identifies the different sets by displaying their names on the screen 136 to enable the customer to select one of the sets to be used for generating and displaying the two-dimensional symbol 144. This selection can be performed by activating a virtual radio button adjacent the displayed name, or by a like selection technique.

Thus, if a customer is asked for, and wishes to provide, only personal information, all the customer need do is select the “personal code” of FIG. 6, and the device controller 138 will collect the entered information for that set and generate a two-dimensional symbol 144 that only contains data from the fields 200-218. The customer simply presents that symbol 144 to the scanner 40, which, in turn, captures the image of the symbol 144, and retrieves and parses that data, not only expeditiously, but also without compromising the customer's security, or embarrassing the customer in any way.

Similarly, if a customer is asked for payment to complete the transaction, all the customer need do is select the “financial code” of FIG. 6, and the device controller 138 will collect the entered information for that set and generate a two-dimensional symbol 144 that only contains data from the fields 220-226. The customer simply presents that symbol 144 to the scanner 40, which, in turn, captures the image of the symbol 144, and retrieves and parses that data, not only expeditiously, but also without compromising the customer's security. This feature serves as a replacement for the customer's credit/debit card. Of course, the customer can enter financial textual information for multiple cards, and can assign separate names for the cards, in which case, each of these differently named cards can be displayed on the display menu of FIG. 6. Thus, all of the customer's credit/debit cards can be replaced.

Of course, if the customer wishes to provide both the personal information and the financial information at the same time, then all the customer need do is select the “master code” of FIG. 6, and the device controller 138 will collect the entered information for that set and generate a two-dimensional symbol 144 that contains data from all the fields 200-226. The customer simply presents that symbol 144 to the scanner 40, which, in turn, captures the image of the symbol 144, and retrieves and parses that data, not only expeditiously, but also without compromising the customer's security.

Advantageously, the device controller 138 executes an application that has been downloaded onto the device 12. In response to selection by the customer of the menus of FIGS. 4-6, the device controller 138 presents these screenshots on the screen 136. The device controller 138 can prompt the customer to complete the various fields. The entry of data into the fields of FIG. 4, and the selection, naming and saving of the fields in FIG. 5, can be performed in advance of a shopping trip, during an initial setup procedure. Of course, these actions can also be done in situ in the retail establishment, or at the station 10. The customization and editing of which fields to select and include in the two-dimensional symbol 144, at any desired time, are a significant improvement over the known art.

In accordance with another feature of this invention, a method of expediting checkout at a point-of-sale station, is performed by enabling a customer to enter into a mobile electronic device at least one of personal textual information that identify the customer and financial textual information that identify how the customer intends to pay for items to be purchased at the station, generating a two-dimensional symbol from the entered textual information, displaying the two-dimensional symbol on a display screen of the device, and electro-optically reading the displayed two-dimensional symbol by image capture to retrieve the entered textual information.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A system for expediting checkout at a point-of-sale station, comprising:
a mobile electronic device having a customer interface for enabling the customer to enter at least one of personal textual information that identify the customer and financial textual information that identify how the customer intends to pay for items to be purchased at the station, a device controller for generating a two-dimensional symbol from the entered textual information, and a display screen on which the two-dimensional symbol is displayed by the device controller;
an electro-optical scanner at the point-of-sale station, and operative for electro-optically reading the displayed two-dimensional symbol by image capture to retrieve the entered textual information;
wherein the device controller is operative, in a text mode of operation, for displaying, on the display screen, a plurality of textual fields in which the at least one of the personal textual information and the financial textual information are entered; and
wherein the device controller is operative, in a generate mode of operation, for enabling the customer to select a set of selected textual fields from the plurality of textual fields, and for generating the two-dimensional symbol from the entered textual information in the set of selected textual fields while excluding from the two-dimensional symbol all textual information in the remaining textual fields that are not selected from the plurality of textural fields.

2. The system of claim 1, wherein the device is one of a cellular telephone, a smartphone, a personal digital assistant, a tablet, a computer, an e-reader, a media player, and like portable electronic device.

3. The system of claim 1, wherein the scanner is one of a handheld, portable scanner; a stand-mounted, stationary scanner; a vertical slot scanner; a flat-bed, horizontal slot scanner; and a bi-optical, dual window scanner.

4. The system of claim 1, wherein the personal textual information includes at least one of the customer's name, address, telephone number, email address, age, and website.

5. The system of claim 1, wherein the financial textual information includes at least one of the customer's payment card type, card number, expiration date and security code.

6. (canceled)

7. The system of claim 1, wherein the device controller is operative, in the generate mode of operation, for enabling the customer to select different sets of the textual fields, and for generating the two-dimensional symbol from the entered textual information in each set of the selected textual fields.

8. The system of claim 7, wherein the device controller is operative, in a display mode of operation, for identifying the different sets to enable the customer to select one of the sets to be used for generating the two-dimensional symbol.

9. The system of claim 8, wherein one of the identified sets contains only the personal textual information, wherein another of the identified sets contains only the financial textual information, and wherein still another of the identified sets contains both the personal textual information and the financial textual information.

10. A method of expediting checkout at a point-of-sale station, comprising:
enabling a customer to enter into a mobile electronic device at least one of personal textual information that identify the customer and financial textual information that identify how the customer intends to pay for items to be purchased at the station;
generating a two-dimensional symbol from the entered textual information;
displaying the two-dimensional symbol on a display screen of the device;
electro-optically reading the displayed two-dimensional symbol by image capture to retrieve the entered textual information;
displaying on the display screen, in a text mode of operation, a plurality of textual fields in which the at least one of the personal textual information and the financial textual information are entered; and
enabling the customer to select, in a generate mode of operation, a set of selected textual fields from the plurality of textual fields, and generating the two-dimensional symbol from the entered textual information in the sit of selected textual fields while excluding from the two-dimensional symbol all textual information in the remaining textual fields that are not selected from the plurality of textual fields.

11. The method of claim 10, and configuring the device as one of a cellular telephone, a smartphone, a personal digital assistant, a tablet, a computer, an e-reader, a media player, and like portable device.

12. The method of claim 10, wherein the reading is performed by one of a handheld, portable scanner; a stand-mounted, stationary scanner; a vertical slot scanner; a flat-bed, horizontal slot scanner; and a bi-optical, dual window scanner.

13. The method of claim 10, and configuring the personal textual information as at least one of the customer's name, address, telephone number, email address, age, and website.

14. The method of claim 10, and configuring the financial textual information as at least one of the customer's payment card type, card number, expiration date and security code.

15. (canceled)

16. The method of claim 10, and enabling the customer to select, in the generate mode of operation, different sets of the textual fields, and generating the two-dimensional symbol from the entered textual information in each set of the selected textual fields.

17. The method of claim 16, and identifying, in a display mode of operation, the different sets to enable the customer to select one of the sets to be used for generating the two-dimensional symbol.

18. The method of claim 17, and containing only the personal textual information in one of the identified sets, and containing only the financial textual information in another of the identified sets, and containing both the personal textual information and the financial textual information in still another of the identified sets.

19. A mobile electronic device for expediting checkout at a point-of-sale station, comprising:
a customer interface for enabling a customer to enter at least one of personal textual information that identify the customer and financial textual information that identify how the customer intends to pay for items to be purchased at the station;
a device controller for generating a two-dimensional symbol from the entered textual information; and
a display screen on which the two-dimensional symbol is displayed by the device controller.
wherein the device controller is operative, in a text mode of operation, for displaying, on the display screen, a plurality of textual fields in which the at least one of the personal textual information and the financial textual information are entered; wherein the device controller is further operative, in a generate mode of operation, for enabling the customer to select a set of selected textual fields from the plurality of textual fields, and for generating the two-dimensional symbol from the entered textual information in the set of selected textual fields while excluding from the two-dimensional symbol all textual information in the remaining textual fields that are not selected from the plurality of textual fields; wherein the device controller is further operative, in a display mode of operation, for identifying a different sets to enable the customer to select one of the sets to be used for generating the two-dimensional symbol; and wherein one of the identified sets contains only the personal textual information, wherein another of the identified sets contains only the financial textual information, and wherein still another of the identified sets contains both the personal textual information and the financial textual information.

20. (canceled)
